(19) United States
(12) Patent Application Publication
(10) Pub. No.: US 2013/0183899 A1
(43) Pub. Date: Jul. 18, 2013

(54) WIRELESS KEYBOARD FOR MOBILE DEVICE

(71) Applicant: Blagojce Gorsev, Malmo (SE)

(72) Inventor: Blagojce Gorsev, Malmo (SE)

(73) Assignee: SONY MOBILE COMMUNICATIONS AB, Lund (SE)

(21) Appl. No.: 13/823,508

(22) PCT Filed: May 18, 2011
(86) PCT No.: PCT/IB11/52185

§ 371 Date: Mar. 14, 2013

(51) Int. Cl. H04B 5/00

(52) U.S. Cl. CPC H04B 5/0031
USPC 455/41.1

(57) ABSTRACT

A mobile device detects proximity of a keyboard accessory. The keyboard accessory includes a full keyboard configured to receive keystroke input from a user and to wirelessly transmit keystroke signals to the mobile device. The mobile device activates, based on detection of the keyboard accessory, a near-field communication (NFC) interface to generate a carrier field that provides power for the keyboard accessory. The mobile device receives, from the keyboard accessory, a keystroke signal via the NFC interface and processes the keystroke signal as user input for the primary unit

### BACKGROUND

Manufactures typically offer various models of mobile devices (e.g., mobile phones). In some cases, models may be very similar except for one or more featured components, such as a full keyboard, camera, amount of memory, etc. However, models are typically developed and tested as separate devices with different certifications due, for example, to electrostatic discharge (ESD) differences caused by the different components.

### SUMMARY

According to one aspect, a mobile terminal may include a primary unit with a first near-field communication (NFC) interface configured to receive a keystroke signal from a keyboard accessory, and a device driver configured to process the keystroke signal for an application associated with the primary unit. The keyboard accessory may include a keyboard configured to receive a keystroke from a user, and a second NFC interface configured to transmit, to the primary unit, the keystroke signal corresponding to the keystroke from the user.

Additionally, the primary unit may further include a power source, wherein the first NFC interface is further configured to generate a carrier field for the second NFC interface using the power source.

Additionally, the keyboard accessory may include a mechanism to selectively permit the keyboard to receive input from a user.

Additionally, the mobile terminal may include the keyboard accessory, and the primary unit and the keyboard accessory may be configured to be mechanically attached.

Additionally, the primary unit may include an accessory detector to detect one or more of: a physical attachment of the keyboard accessory, or an opening of the keyboard, wherein the primary unit is configured to activate the first NFC interface when the accessory detector detects one or more of the physical attachment or the opening of the keyboard.

Additionally, the keyboard accessory may be configured to be interchangeable with a battery cover for the primary unit.

Additionally, the mobile terminal may include a battery cover for the primary unit, wherein the battery cover is interchangeable with the keyboard accessory.

Additionally, the primary unit may be one of a smart phone, a cellular radiotelephone, a Personal Communications System (PCS) terminal, a personal digital assistant (PDA), a camera, a global positioning system (GPS) device, a tablet computer, or a portable gaming system.

Additionally, the primary unit may be configured to propagate another carrier field after receiving the keystroke signal.

Additionally, the keyboard accessory may further include a separate power supply.

According to another aspect, a method may be performed by a primary unit of a mobile terminal. The method may include: detecting proximity of a keyboard accessory, wherein the keyboard accessory includes a keyboard configured to receive keystroke input from a user; activating, based on the detecting, a NFC interface to generate a carrier field; receiving, from the keyboard accessory, a keystroke signal via the NFC interface; and processing, by the primary unit, the keystroke signal as user input for the primary unit.

Additionally, the method may include generating another carrier field in response to receiving the keystroke signal.

Additionally, the detecting proximity of the keyboard accessory may include detecting a physical attachment of the keyboard accessory to the primary unit, or detecting opening of the keyboard.

Additionally, the method may include detecting a removal of the keyboard accessory from the proximity of the primary unit, and deactivating the NFC interface based on the detecting the removal.

According to a further aspect, a mobile device may include an accessory detector configured to detect proximity of a keyboard accessory, a NFC interface, and a processor. The NFC interface may be configured to generate a carrier field for a passive communications mode with another NFC interface, and receive, from the keyboard accessory, a keystroke signal using the passive communications mode. The processor may be configured to activate, based on the accessory detector detecting the proximity of the keyboard accessory, the NFC interface to generate the carrier field, and process the received keystroke signal for an application running on the mobile device.

Additionally, the mobile device may include the keyboard accessory and a housing configured to allow the keyboard accessory to be mechanically attached to the mobile device.

Additionally, the accessory detector may be further configured to detect when a keyboard of the keyboard accessory is accessible to a user, and the processor may be further configured to activate the NFC interface, based on the accessory detector detecting the accessibility of the keyboard.

Additionally, the keyboard accessory may include a full keyboard, and the mobile device may further include a second input device to receive text input from a user.

Additionally, the accessory detector maybe further configured to detect when the keyboard accessory is no longer in proximity to the mobile device or when a keyboard of the keyboard accessory is not accessible to a user; and the processor may be further configured to deactivate the NFC interface when the accessory detector detects that the keyboard accessory is no longer in proximity to the mobile device or that a keyboard of the keyboard accessory not accessible to a user.

Additionally, the processor may be further configured to generate another carrier field for the passive communications mode with the other NFC interface after receiving the keystroke signal using the passive communications mode.

### BRIEF DESCRIPTION OF THE DRAWINGS

FIGS. 1A and 1B are diagrams of an example of a mobile terminal according to an implementation described herein;

FIG. 2 is a block diagram illustrating components of the primary unit of FIGS. 1A and 1B according to an implementation;

FIGS. 3A and 3B are simplified side cross-section views of the mobile terminal of FIGS. 1A-2 according to implementations described herein;

FIG. 4 is a block diagram of exemplary functional components of the primary unit of FIGS. 1A-3; and

FIG. 5 is a flowchart of an exemplary process for using a wireless keyboard accessory with a mobile terminal.

### DETAILED DESCRIPTION OF THE PREFERRED EMBODIMENTS

The following detailed description refers to the accompanying drawings. The same reference numbers in different drawings may identify the same or similar elements. Also, the following description does not limit the invention. Rather, the scope of the invention is defined by the appended claims.

In implementations described herein, a mobile device may be configured to receive a back cover with an integrated keyboard (referred to herein as a back cover keyboard) or a standard back cover. The mobile device and the back cover keyboard may each include a near-field communication (NFC) interface to permit wireless communication between the back cover keyboard and the mobile device. In one implementation, the back cover keyboard may be powered by the mobile device via the NFC interfaces (e.g., using the battery/power source of the mobile device). In another implementation, the back cover keyboard may include a separate battery.

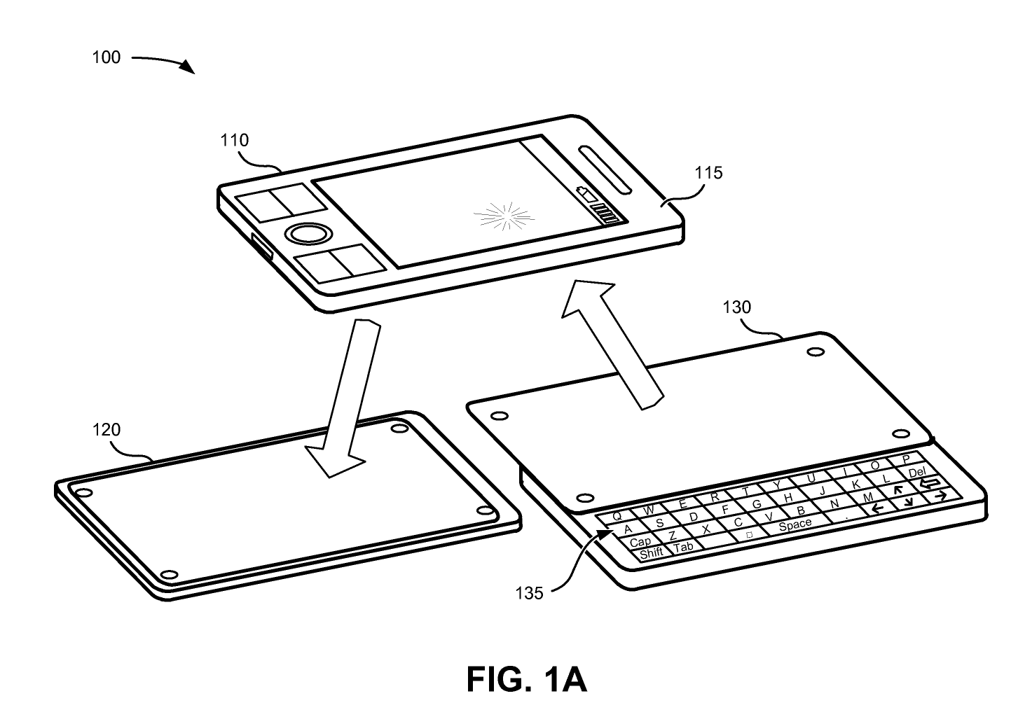

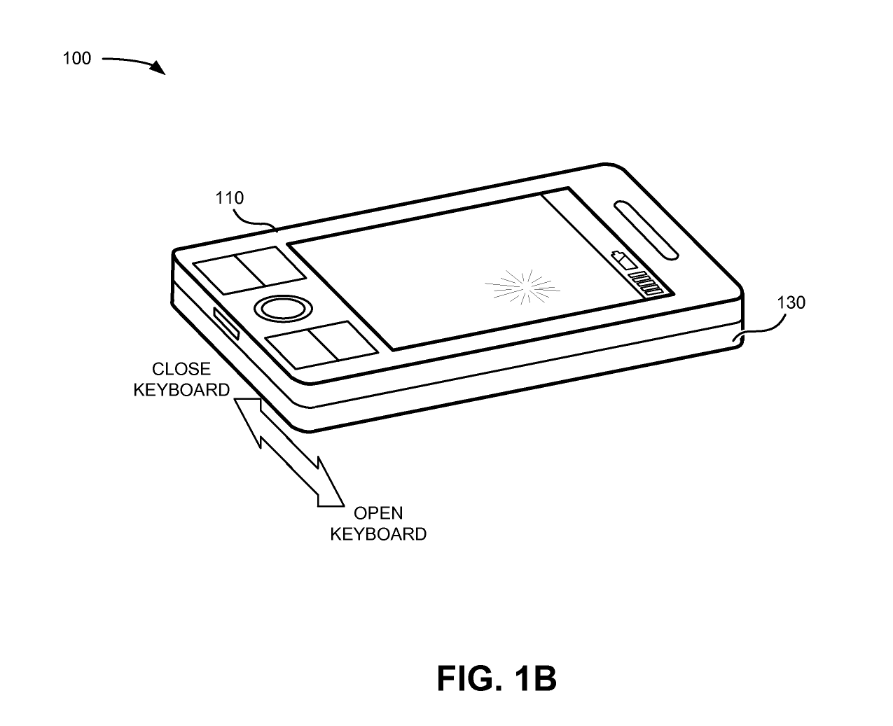

FIGS. 1A and 1B provide diagrams of an example of a mobile terminal 100 according to an implementation described herein. Mobile terminal 100 may include a primary unit 110 that may receive accessories such as a battery cover 120 or a keyboard accessory 130. FIG. 1A illustrates an assembly view of mobile terminal 100. FIG. 1B illustrates mobile terminal 100 assembled with keyboard accessory 130 in a closed position.

Referring to FIG. 1A, primary unit 110 may provide a platform for a user to make and receive telephone calls, send and receive messages (e.g., electronic mail, text messages, multi-media messages, SMS messages, etc.), play music, play games, take pictures/videos and execute various other applications. Primary unit may include a cellular radiotelephone with or without a multi-line display; a Personal Communications System (PCS) terminal that may combine a cellular radiotelephone with data processing, facsimile and data communications capabilities; a tablet computing device, a personal digital assistant (PDA) that can include a radiotelephone, pager, Internet/Intranet access, Web browser, organizer, calendar and/or a global positioning system (GPS) receiver; a smart phone; a camera; a GPS device; a portable gaming system; or another handheld electronic appliance that can be configured to receive alphanumeric text input. For example, primary unit 110 may include a speaker(s), a display, control buttons, a microphone, a touch panel, and a power source (e.g., a battery). It should be understood that primary unit 110 may include other and/or different components. For example, primary unit 110 may include a camera and a flash mechanism used to take pictures and/or videos, a connector or interface for charging primary unit 110, etc.

Primary unit 110 may include a housing 115. Housing 115 may protect the components of mobile terminal 100 from outside elements and provide a mounting surface for certain components and/or accessories, such as battery cover 120 or a keyboard accessory 130. Housing 115 may include an opening on a back surface (not shown) of primary unit 110 to access internal components of primary unit 110, such as a battery, memory card, etc. The opening may be shielded by attaching battery cover 120 or keyboard accessory 130 to housing 115. In one implementation, primary unit 110 may also include an attachment mechanism (e.g., screw holes, clips, tabs, etc., not shown) to allow battery cover 120 or keyboard accessory 130 to be physically attached to housing 115 or another part of primary unit 110.

Battery cover 120 may include a structure configured to mechanically attach to a portion of housing 115. In one implementation, all or a portion of battery cover 120 may be removably attached to permit access to internal components of primary unit 110. Battery cover 120 may be formed from a variety of materials, such as plastic, metal, or a composite.

Keyboard accessory 130 may include a structure configured to mechanically attach to a portion of housing 115 (e.g., in a manner similar to that used for battery cover 120). Keyboard accessory 130 may be configured to receive user input and to wirelessly transmit user input signals to primary unit 110. For example, keyboard accessory 130 may include a keyboard 135, such as a sliding keyboard, to receive keystrokes from a user and a NFC interface (not shown) to communicate the keystrokes to primary unit 110. Keyboard 135 may include a full keyboard (e.g., a keyboard that includes a separate key for each letter of a modern Latin alphabet, such as a QWERTY keyboard, a Dvorak keyboard, etc.) to permit text entry, from a user, for applications running on primary unit 110. In one implementation, keyboard 135 may slide between an open position (as shown in FIG. 1A) that exposes keys of keyboard 135 to a user and a closed position (as shown in FIG. 1B) that hides keys of keyboard 135. In other implementations, keyboard 135 may include an on/off switch, cover, or another mechanism that selectively makes keys of keyboard 135 accessible/inaccessible to a user.

Separation of keyboard accessory 130 and primary unit 110 may provide advantages for development and testing of mobile terminal 100, including electrostatic discharge (ESD) certification. For example, by not including keyboard accessory 130 as an integral part of primary unit 110, primary unit 110 can be tested/certified as a single model to include either battery cover 120 or keyboard accessory 130. Keyboard accessory 130 can then be separately certified as an accessory for mobile terminal 100.

Although FIGS. 1A and 1B shows an exemplary configuration of mobile terminal 100, in other implementations, mobile terminal 100 may be configured differently than depicted in FIGS. 1A and 1B. For example, in another implementation keyboard accessory 130 may mechanically attached to primary unit 110 with a hinged configuration to provide a clamshell orientation for mobile terminal 100.

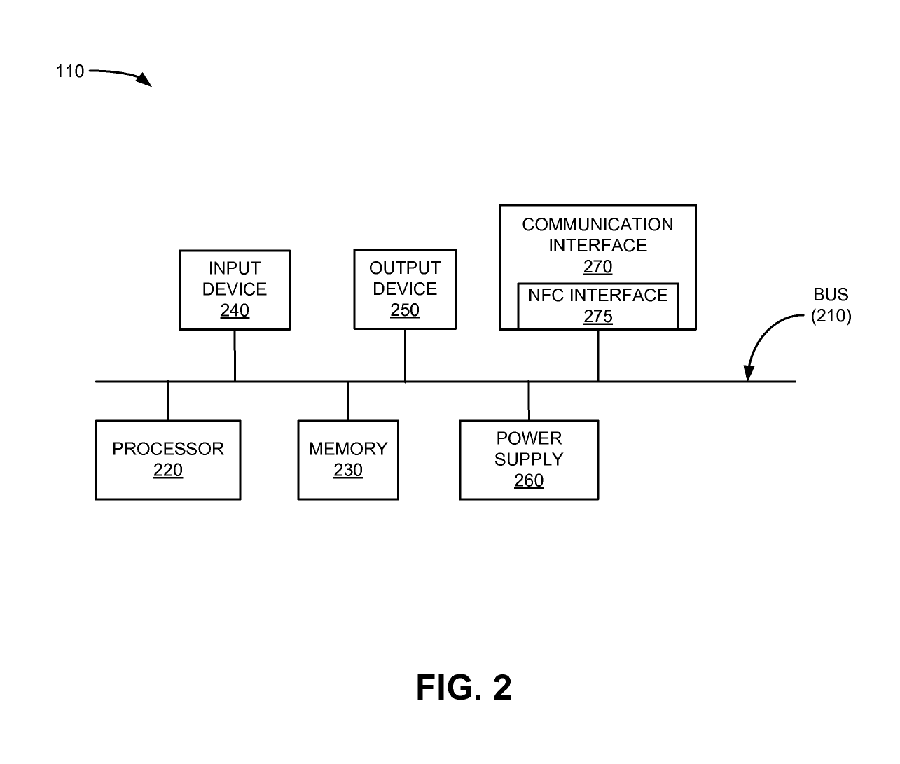

FIG. 2 is a diagram illustrating components of primary unit 110 according to an exemplary implementation. Primary unit 110 may include a bus 210, a processor 220, a memory 230, an input device 240, an output device 250, a power supply 260, and a communication interface 270. Bus 210 permits communication among the components of primary unit 110. One skilled in the art would recognize that primary unit 110 may be configured in a number of other ways and may include other or different elements. For example, primary unit 110 may include one or more modulators, demodulators, encoders, decoders, etc., for processing data.

Processor 220 may include a processor, microprocessor, an application specific integrated circuit (ASIC), field programmable gate array (FPGA) or other processing logic. Processor 220 may execute software instructions/programs or data structures to control operation of primary unit 110.

Memory 230 may include a random access memory (RAM) or another type of dynamic storage device that stores information and instructions for execution by processor 220; a read only memory (ROM) or another type of static storage device that stores static information and instructions for use by processor 220; a flash memory (e.g., an electrically erasable programmable read only memory (EEPROM)) device for storing information and instructions; and/or some other type of magnetic or optical recording medium and its corresponding drive. Memory 230 may also be used to store temporary variables or other intermediate information during execution of instructions by processor 220. Instructions used by processor 220 may also, or alternatively, be stored in another type of computer-readable medium accessible by processor 220.

Input device 240 may include mechanisms that permit an operator to input information to primary unit 110, such as a microphone, control buttons, a gesture-based device, an optical character recognition (OCR) based device, a joystick, a virtual keyboard, a speech-to-text engine, a mouse, a pen, voice recognition and/or biometric mechanisms, etc. Generally, in implementations described herein, input device 240 may not provide a dedicated full keyboard. Output device 250 may include one or more mechanisms that output information to the user, including a display, one or more speakers, etc.

Power supply 260, also referred to herein as battery 260, may include one or more batteries or other components used to supply power to components of primary unit 110. In implementations described herein, power supply 260 may also provide power to keyboard accessory 130 using, for example, a NFC interface.

Communication interface 270 may include one or more transceivers that enable primary unit 110 to communicate with other devices via wired, wireless or optical mechanisms. For example, communication interface 270 may include one or more radio frequency (RF) transmitters, receivers and/or transceivers and one or more antennas for transmitting and receiving RF data. Communication interface 270 may also include a modem or an Ethernet interface to a local area network (LAN) for communicating via a network.

In an exemplary implementation, communication interface 270 includes a NFC interface 275 that allows primary unit 110 to communicate with keyboard accessory 130 (or other accessories) when primary unit 110 is in close proximity (e.g., within range of an electromagnetic field generated by NFC interface 275) to keyboard accessory 130. Generally, NFC interface 275 may include a short range (e.g., 4-10 cm), high frequency (e.g., 13.56 MHz) system that enables the exchange of data with another device that includes a similar NFC system. In one implementation, NFC interface 275 may include an RF transmitter to generate a carrier field for a passive communications from a NFC interface in keyboard accessory 130.

Primary unit 110, as described in detail below, may perform processing associated with detecting signals from keyboard accessory 130 and performing one or more functions based on the detected signals. In an exemplary implementation, primary unit 110 may perform all or some of these operations in response to processor 220 executing sequences of instructions contained in a computer-readable medium, such as memory 230. Such instructions may be read into memory 230 from another computer-readable medium via, for example, communication interface 270. A computer-readable medium may be defined as a non-transitory memory device. A memory device may include space within a single physical memory device or spread across multiple physical memory devices. In alternative embodiments, hard-wired circuitry may be used in place of or in combination with software instructions to implement processes consistent with the invention. Thus, implementations described herein are not limited to any specific combination of hardware circuitry and software.

Although FIG. 2 shows exemplary components of mobile device 110, in other implementations, mobile device 110 may contain fewer, different, differently-arranged, or additional components than depicted in FIG. 2. In still other implementations, one or more components of mobile device 110 may perform one or more other tasks described as being performed by one or more other components of mobile device 110.

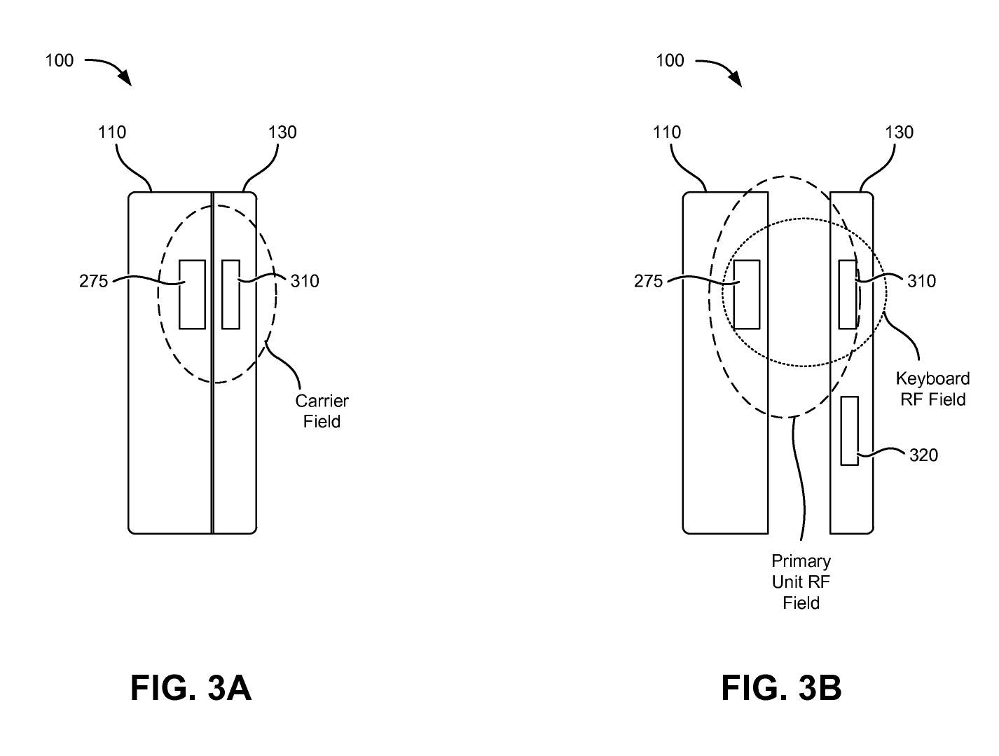

FIGS. 3A and 3B provide a simplified side cross-section view of mobile terminal 100 with primary unit 110 and keyboard accessory 130. FIG. 3A shows a configuration of mobile terminal 100 using a passive communication mode. FIG. 3B shows a configuration of mobile terminal 100 using an active communication mode.

As shown in FIG. 3A, primary unit 110 may include NFC interface 275, and keyboard accessory 130 may include a NFC interface 310. In one implementation, NFC interface 275 and NFC interface 310 may operate in a passive communication mode, where NFC interface 275 may actively generate an RF field that can power a passive target (e.g., NFC interface 310 in keyboard accessory 130). In a passive communication mode, NFC interface 275 serves as an initiator device and NFC interface 310 serves as a target device. NFC interface 275 provides a carrier field, and NFC interface 310 answers by modulating the existing field. Thus, in the passive communication mode, NFC interface 310 may draw its operating power from the electromagnetic field provided by NFC interface 275, thus making NFC interface 310 device a transponder.

Still referring to FIG. 3A, when NFC interface 310 in keyboard accessory 130 is within range of the carrier field from NFC interface 275 (e.g., when keyboard accessory 130 is mechanically attached to housing 115 of primary unit 110), NFC interface 275 may “read” keystroke information from NFC interface 310. For example, primary unit 110 may activate NFC interface 275 to provide a carrier field when keyboard 135 of keyboard accessory 130 is opened (e.g., as illustrated in FIG. 1A). NFC interface 275 may provide a carrier field at regular intervals (e.g., heartbeats) to enable an initial response (e.g., a keystroke signal for a particular key of keyboard 135) from NFC interface 310 of keyboard accessory 130. Upon receiving the initial keystroke signal from NFC interface 310, NFC interface 275 may forward the keystroke signal for processing and generate a next carrier field with power to enable NFC interface 310 to provide a subsequent keystroke signal. NFC interface 275 may receive the subsequent keystroke signal from NFC interface 310 and may iteratively provide carrier field pulses and receive further keystroke signals. If NFC interface 275 does not receive any keystroke signals, NFC interface 275 may continue to provide a carrier field at regular intervals (or, in some cases, constantly) until a keyboard signal is received or until keyboard 135 is closed.

As shown in FIG. 3B, primary unit 110 may include NFC interface 275, and keyboard accessory 130 may include NFC interface 310 and a power supply 320. In the configuration of FIG. 3B, NFC interface 275 and NFC interface 310 may operate in an active communication mode, where both NFC interface 275 and NFC interface 310 communicate by alternately generating their own RF fields. Either of NFC interface 275 or NFC interface 310 may deactivate a corresponding RF field while waiting for data from the other of NFC interface 275 or NFC interface 310.

When configured for an active communication mode, keyboard accessory 130 may also include a power supply 320 for NFC interface 310 to generate its own RF field. Power supply 320 may include one or more batteries, other components, or an external source to supply power to NFC interface 310. In the configuration of FIG. 3B, the active communication mode may permit keyboard accessory 130 to be either mechanically attached to housing 115 of primary unit 110 or to be used as a remote control (e.g., within the range of the RF field of NFC interface 310). In one implementation, using the active communication mode, keyboard accessory 130 and housing 115 may be configured so that keyboard accessory 130 can be attached or detached from housing 115 at the preference of a user. For example, mobile terminal 100 may use a separate battery cover (e.g., battery cover 120) and keyboard accessory 130 together to allow for the convenient removal of keyboard accessory 130.

Although FIGS. 3A and 3B show exemplary components of mobile terminal 100, in other implementations, mobile terminal 100 may contain fewer, different, differently-arranged, or additional components than depicted in FIGS. 3A and 3B. In still other implementations, one or more components of mobile terminal 100 may perform one or more other tasks described as being performed by one or more other components of mobile terminal 100.

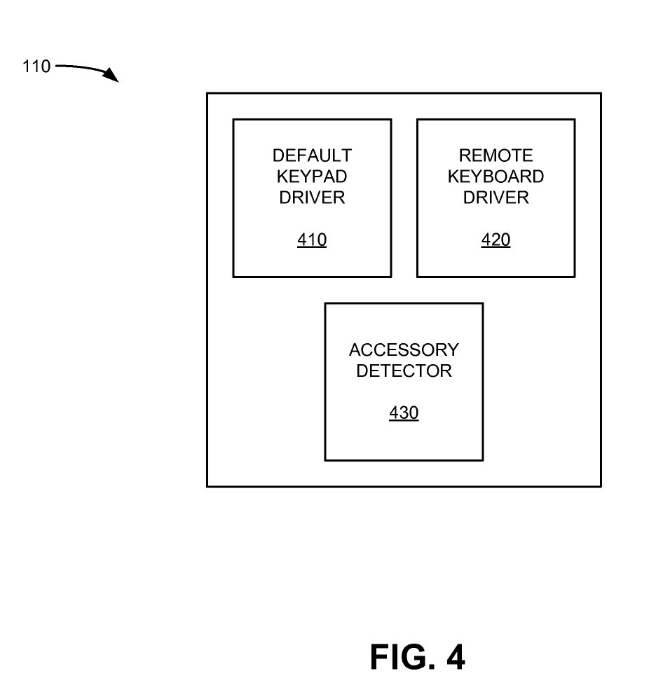

FIG. 4 is a block diagram of functional components of primary unit 110. Functions described in connection with FIG. 4 may be performed, for example, by processor 220 executing instructions stored in memory 230. As shown in FIG. 4, mobile device 110 may include a default keypad driver 410, a remote keyboard driver 420, and an accessory detector 430.

Default keypad driver 410 may include hardware or a combination of hardware and software to convert user input from default keyboard hardware in primary unit 110 (e.g., an alphanumeric keypad, a virtual keyboard, etc.) into keyboard events/signals that may be used by an operating system and/or application running on primary unit 110.

Remote keyboard driver 420 may include hardware or a combination of hardware and software to convert keyboard signals from keyboard accessory 130 (e.g., a QWERTY keyboard, etc.) into keyboard events/input that may be used by an operating system and/or application running on primary unit 110. In one implementation, remote keyboard driver 420 may communicate with NFC interface 275 to confirm receipt of signals sent by NFC interface 310 of keyboard accessory 130 and to instruct NFC interface 275 to propagate a next carrier field for a NFC passive communication mode.

Accessory detector 430 may include hardware or a combination of hardware and software to identify if a remote keyboard (e.g., keyboard accessory 130) is available for use with primary unit 110. For example, accessory detector 430 may include a sensor to detect when keyboard accessory 130 (e.g., using a passive communication mode) is physically attached to housing 115 of primary unit 110 and/or when keyboard 135 is physically positioned (e.g., in an open position) to receive user input.

Accessory detector 430 may also include logic to signal remote keyboard driver 420 and/or NFC interface 275 to begin propagating a carrier field for keyboard accessory 130 when attachment of keyboard accessory 130 and/or opening of keyboard 135 is detected. For example, accessory detector 430 may include a switch, a sensor, or another detection mechanism to identify when keyboard accessory 130 is attached to or removed from primary unit 110. Additionally, or alternatively, accessory detector 430 may use the detection mechanism to identify when keyboard 135 is accessible to a user (e.g., slid to an open position) or in accessible (e.g., slid to closed position). Accessory detector 430 may use the detection mechanism to trigger activation of NFC interface 275 when attachment (e.g., of keyboard accessory 130) or opening (e.g., of keyboard 135) is detected. Conversely, accessory detector 430 may use the detection mechanism to trigger deactivation of NFC interface 275 when removal (e.g., of keyboard accessory 130 from primary unit 110) or closing (e.g., of keyboard 135) is detected.

In one implementation, accessory detector 430 may detect a voltage change associated with the physical attachment/detachment of keyboard accessory 130 or the opening of keyboard 135. Accessory detector 430 may include, for example, an input/output (I/O) pin set to detect a voltage change when keyboard accessory 130 is mechanically attached to primary unit 110. In another implementation, accessory detector 430 may include a material that generates a voltage when its configuration has changed. For example, accessory detector 430 may include an electroactive polymer (EAP) material that generates a different voltage when the material is bent, moved or otherwise displaced from its initial condition (e.g., as a result of keyboard accessory 130 being attached/detached from primary unit 110 or keyboard 135 moving between an open/closed position).

In another implementation, NFC interface 310 of keyboard accessory 130 (e.g., using an active communication mode) may provide a signal to NFC interface 275 of primary unit 110. NFC interface 275 may receive the signal from NFC interface 310 and may forward the signal (or an indication that a signal was received) to accessory detector 430 to indicate that keyboard accessory 130 is within proximity of primary unit 110.

Although FIG. 4 show exemplary functional components of primary unit 110, in other implementations, primary unit 110 may contain fewer, different, differently-arranged, or additional functional components than depicted in FIG. 4. In still other implementations, one or more functional components of primary unit 110 may perform one or more other tasks described as being performed by one or more other functional components of primary unit 110.

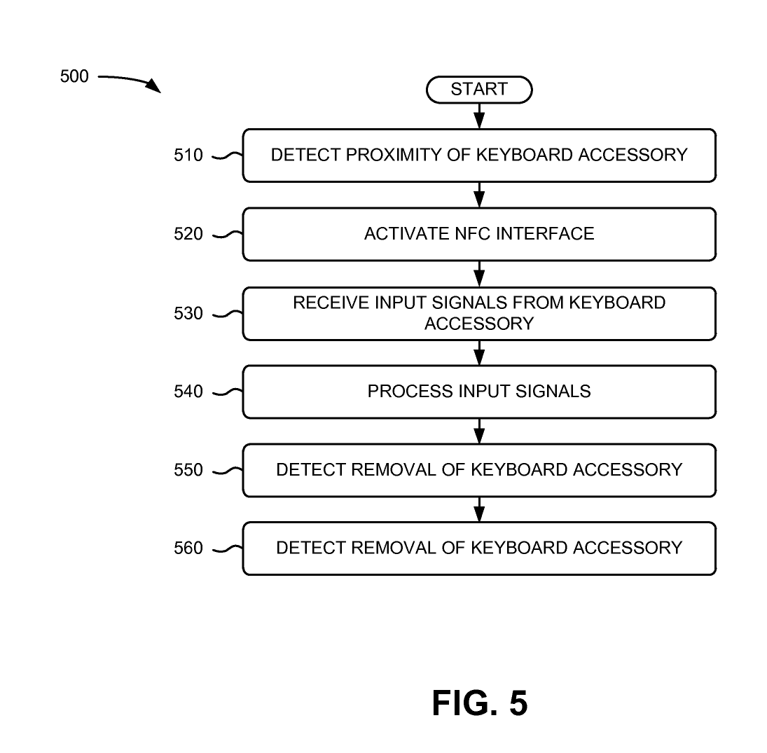

FIG. 5 is a flow diagram illustrating an exemplary process 500 for using a wireless keyboard accessory with a mobile terminal. Process 500 may be performed by one or more components of mobile terminal 100. In other implementations, process 500 may be performed by another device or group of devices including or excluding mobile terminal 100.

Process 500 may include detecting a wireless keyboard accessory within proximity of a primary unit 110 of the mobile terminal 100 (block 510). For example, as shown in FIG. 1A, a user (or manufacturer) may remove battery cover 120 and attach keyboard accessory 130 to primary unit 110. In one implementation, keyboard accessory 130 may be mechanically attached using clips, screws, tongue-in-grove mechanisms, etc. In another implementation, keyboard accessory 130 may not be physically attached, but may be placed within a distance sufficient to enable NFC transmissions between primary unit 110 and keyboard accessory 130. In one implementation, accessory detector 430 of primary unit 110 may detect when keyboard accessory 130 (e.g., using a passive communication mode) is physically attached to housing 115 of primary unit 110. In another implementation, accessory detector 430 of primary unit 110 may detect when keyboard 135 is moved to an open position (e.g., that exposes keys of keyboard 135 to a user).

Process 500 may include activating a NFC interface for the keyboard accessory (block 520). For example, primary unit 110 may activate NFC interface 275 to provide a carrier field when keyboard 135 of keyboard accessory 130 is opened. NFC interface 275 may provide a carrier field at regular intervals (e.g., heartbeats) to enable an initial response (e.g., a keystroke signal for a particular key of keyboard 135) from NFC interface 310 of keyboard accessory 130.

Process 500 may include receiving a key signal from the keyboard accessory (block 530) and processing the key signal (block 540). For example, upon receiving the initial keystroke signal from NFC interface 310, NFC interface 275 may forward the keystroke signal (e.g., to remote keyboard driver 420) for processing and generate a next carrier field with power to enable NFC interface 310 to provide a subsequent keystroke signal. Remote keyboard driver 420 may convert keyboard signals from keyboard accessory 130 into keyboard events/input that may be used by an operating system and/or application running on primary unit 110. For example, remote keyboard driver 420 may identify entry of a particular alphanumeric input from keyboard 135. In one implementation, remote keyboard driver 420 may communicate with NFC interface 275 to confirm receipt of signals sent by NFC interface 310 of keyboard accessory 130 and to instruct NFC to propagate a next carrier field for a NFC passive communication mode.

Process 500 may include detecting removal and/or closing of the keyboard accessory (block 550) and deactivating the NFC interface (block 560). For example, primary unit 110 (e.g., NFC interface 275) may continue to propagate a carrier field at regular intervals until keyboard 135 is closed. Primary unit 110 (e.g., accessory detector 430) may include a switch, a sensor, or another detection mechanism to identify when keyboard accessory 130 is attached to or removed from primary unit 110. Additionally, or alternatively, accessory detector 430 may use the detection mechanism to identify when keyboard 135 is accessible to a user (e.g., slid to an open position) or in accessible (e.g., slid to closed position). Accessory detector 430 may use the detection mechanism to trigger activation of NFC interface 275 when attachment (e.g., of keyboard accessory 130) or opening (e.g., of keyboard 135) is detected. Conversely, accessory detector 430 may use the detection mechanism to trigger deactivation of NFC interface 275 when removal (e.g., of keyboard accessory 130 from primary unit 110) or closing (e.g., of keyboard 135) is detected.

As described above, systems and/or methods described herein may detect proximity of a keyboard accessory to a primary unit. The keyboard accessory may include a full keyboard configured to receive keystroke input from a user and to wirelessly transmit keystroke signals to the primary unit. The primary unit may activate, based on detection of the keyboard accessory, a near-field communication (NFC) interface to generate a carrier field that provides power for the keyboard accessory. The primary unit may receive, from the keyboard accessory, a keystroke signal via the NFC interface and may process the keystroke signal as user input for the primary unit.

The systems and/or methods described herein may permit design and development of mobile terminals as a single model that may interchangeably offer a full keyboard. Development of a single model may streamline development and eliminate the need for separate ESD certification for mobile terminal models with a keyboard.

The foregoing description of the embodiments described herein provides illustration and description, but is not intended to be exhaustive or to limit the invention to the precise form disclosed. Modifications and variations are possible in light of the above teachings or may be acquired from the practice of the invention.

In addition, while a series of blocks has been described with respect to FIG. 5, the order of the blocks may be varied in other implementations consistent with the invention. Moreover, non-dependent acts may be performed in parallel.

It will also be apparent to one of ordinary skill in the art that aspects of the invention, as described above, may be implemented in computer devices, cellular communication devices/systems, media playing devices, methods, and/or computer program products. Accordingly, aspects of the present invention may be embodied in hardware and/or in software (including firmware, resident software, micro-code, etc.). Furthermore, aspects of the invention may take the form of a computer program product on a computer-usable or computer-readable storage medium having computer-usable or computer-readable program code embodied in the medium for use by or in connection with an instruction execution system. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as a processor, a microprocessor, an ASIC, an FPGA or other processing logic, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Further, the phrase “based on,” as used herein is intended to mean “based, at least in part, on” unless explicitly stated otherwise.

The scope of the invention is defined by the claims and their equivalents.

1. A mobile terminal, comprising:
a primary unit including:
a first near-field communication (NFC) interface configured to receive a keystroke signal from a keyboard accessory, and
a device driver configured to process the keystroke signal for an application associated with the primary unit; and
the keyboard accessory including:
a keyboard configured to receive a keystroke from a user, and
a second NFC interface configured to transmit, to the primary unit, the keystroke signal corresponding to the keystroke from the user.

2. The mobile terminal of claim 1, wherein the primary unit further includes a power source, and wherein the first NFC interface is further configured to generate a carrier field for the second NFC interface using the power source.

3. The mobile terminal of claim 1, wherein the keyboard accessory includes a mechanism to selectively permit the keyboard to receive input from a user.

4. The mobile terminal of claim 1, further comprising:
the keyboard accessory, wherein the primary unit and the keyboard accessory are configured to be mechanically attached.

5. The mobile terminal of claim 1, wherein the primary unit includes an accessory detector to detect one or more of:
a physical attachment of the keyboard accessory, or
an opening of the keyboard, wherein the primary unit is configured to activate the first NFC interface when the accessory detector detects one or more of the physical attachment or the opening of the keyboard.

6. The mobile terminal of claim 1, wherein the keyboard accessory is configured to be interchangeable with a battery cover for the primary unit.

7. The mobile terminal of claim 1, further comprising:
a battery cover for the primary unit, wherein the battery cover is interchangeable with the keyboard accessory.

8. The mobile terminal of claim 1, wherein the primary unit is one of:
a smart phone,
a cellular radiotelephone,
a Personal Communications System (PCS) terminal,
a personal digital assistant (PDA),
a camera,
a global positioning system (GPS) device,
a tablet computer, or
a portable gaming system.

9. The mobile terminal of claim 1, wherein the primary unit is configured to generate another carrier field after receiving the keystroke signal.

10. The mobile terminal of claim 1, wherein the keyboard accessory further includes a separate power supply.

11. A method performed by a primary unit of a mobile terminal, the method comprising:
detecting, by the primary unit, proximity of a keyboard accessory, wherein the keyboard accessory includes a keyboard configured to receive keystroke input from a user;
activating, by the primary unit and based on the detecting, a near-field communication (NFC) interface to generate a carrier field;
receiving, by the primary unit and from the keyboard accessory, a keystroke signal via the NFC interface; and
processing, by the primary unit, the keystroke signal as user input for the primary unit.

12. The method of claim 11, further comprising:
generating, by the primary unit, another carrier field in response to receiving the keystroke signal.

13. The method of claim 11, wherein the detecting proximity of the keyboard accessory comprises:
detecting a physical attachment of the keyboard accessory to the primary unit, or
detecting opening of the keyboard.

14. The method of claim 11, further comprising:
detecting a removal of the keyboard accessory from the proximity of the primary unit; and
deactivating the NFC interface based on the detecting the removal.

15. A mobile device, comprising:
an accessory detector configured to detect proximity of a keyboard accessory;
a near-field communication (NFC) interface configured to:
generate a carrier field for a passive communications mode with another NFC interface, and
receive, from the keyboard accessory, a keystroke signal using the passive communications mode; and
a processor configured to:
activate, based on the accessory detector detecting the proximity of the keyboard accessory, the NFC interface to generate the carrier field, and
process the received keystroke signal for an application running on the mobile device.

16. The mobile device of claim 15, further comprising:
a housing configured to allow the keyboard accessory to be mechanically attached to the mobile device; and
the keyboard accessory.

17. The mobile device of claim 15, wherein the accessory detector is further configured to detect when a keyboard of the keyboard accessory is accessible to a user, and wherein the processor is further configured to activate the NFC interface, based on the accessory detector detecting the accessibility of the keyboard.

18. The mobile device of claim 15, wherein the keyboard accessory includes a full keyboard, and wherein the mobile device further comprises a second input device to receive text input from a user.

19. The mobile device of claim 15, wherein the accessory detector is further configured to detect:
when the keyboard accessory is no longer in proximity to the mobile device, or
when a keyboard of the keyboard accessory is not accessible to a user; and
wherein the processor is further configured to:
deactivate the NFC interface when the accessory detector detects that the keyboard accessory is no longer in proximity to the mobile device or that a keyboard of the keyboard accessory not accessible to a user.

20. The mobile device of claim 15, wherein the processor is further configured to gene a e another carrier field for the passive communications mode with the other NFC interface after receiving the keystroke signal using the passive communications mode.
